(19) United States
(12) Patent Application Publication
(10) Pub. No.: US 2015/0083787 A1
(43) Pub. Date: Mar. 26, 2015

(54) METHOD FOR FIXING HEAT RESISTANT COMPONENT ON A SURFACE OF A HEAT EXPOSED COMPONENT

(71) Applicant: ALSTOM Technology Ltd, Baden (CH)

(72) Inventors: Michael STUER, Niederrohrdorf (CH); Israel CABAN, Wilbraha, MA (US); Mathieu ESQUERRE, Neuenhof (CH)

(21) Appl. No.: 14/488,410

(22) Filed: Sep. 17, 2014

(30) Foreign Application Priority Data
Sep. 20, 2013 (EP) 13185347.5

(51) Int. Cl. B23K 1/19; B23K 1/20

(52) U.S. Cl. CPC B23K 1/19; B23K 1/20
USPC 228/124.1

(57) ABSTRACT

The invention refers to a method for fixing a heat resistant component on a surface of a heat exposed component, by brazing of at least a part of a surface of the heat resistant component limited by a peripheral boundary edge on the surface of the heat exposed component using a molten solder. A first alternative includes:
metallizing the surface of the heat resistant component at least with the exception of an edge area comprising the peripheral boundary edge; and
brazing said metallized surface to the surface of the heat exposed component, wherein at least the surface of the heat resistant component consists of a ceramic material which has a physico-chemical property concerning wettability such that the ceramic material is not wettable by the molten solder, and/or a metal or a metal alloy is used for metallizing which has a physico-chemical property concerning wettability such that the metallizing is wettable by the molten solder.

### CROSS-REFERENCE TO RELATED APPLICATIONS

This application claims priority to European application 13185347.5 filed Sep. 20, 2013, the contents of which are hereby incorporated in its entirety.

### TECHNICAL FIELD

The invention relates to a method for fixing a heat resistant component on a surface of a heat exposed component, by brazing of at least a part of a surface of the heat resistant component limited by a peripheral boundary edge on the surface of the heat exposed component using a molten solder.

### BACKGROUND

The current thermal barrier coatings (TBCs) may reach their application limits in high advanced gas turbines due to the limited capacities to control their micro-structure from the process parameters and the reduced choice of materials suitable for thermal plasma spraying. One way to overcome these limitations is to move away from the TBC coatings and replace them with so called ceramic tiles which can be fixed on the surface of the heat exposed component with different fastening technologies.

The document U.S. Pat. No. 7,198,860 B2 discloses a ceramic tile insulation for gas turbine components with a multitude of ceramic tiles which are bonded to a heat exposed surface of a gas turbine component. A first layer of individual ceramic tiles are bonded to the surface of the gas turbine component which is of ceramic material. A second layer of individual tiles is bonded on top of the first layer.

The ceramic tiles maybe bonded by applying adhesive to the back of each tile, to the surface of the substrate or to both. Each individual tile is than pressed onto the surface of the substrate and a permanent bond is achieved by drying and firing at an elevated temperature up to 1200° C. The tiles are bonded to the substrate over their complete surface facing the bond joint.

EP 0 396 026 A1 discloses a composition in which parts made of ceramic and metal are joined to one another by soldering, wherein an expansion element is arranged between the ceramic and metallic materials, wherein said expansion element being integrally joined to said materials, wherein the expansion element is joined to the materials by soldering, wherein the expansion element is molded in one piece on the metallic material and joined to the ceramic material by soldering. This document uses an expansion element which is connected on the one side with the metallic part and on the other side with the ceramic part.

U.S. Pat. No. 4,690,793 A discloses a nuclear fusion reactor with a new vacuum vessel for enclosing plasma particles where a reactor wall exposed to the above plasma particles has a piled structure. A plurality of heat-resisting ceramic tiles are metallurgically bonded to a metal-base body having a cooling means through a brazing material. The ceramic tiles are preferably composed of sintered silicon carbide of high density and containing a little beryllium oxide between the boundaries of crystal grains. It is our claim 1 very close.

JP 2002 373955 A discloses a power module substrate where a heat sink plate is formed on one surface and a circuit is formed on the other surface through metallization pattern layers formed on the opposite sides of a ceramic basic material or a copper plate to be formed is bonded using metallic brazing materials. The ceramic basic material has non bonded regions extending from the outer circumferential end part of the ceramic basic material to the inside of the opposite surfaces.

JP 1985 0207162 A discloses joining ceramics having a metallized surface layer and metal parts using brazing filler material, where on the metal part which faces the edge portion of the metallized layer, concave portions are formed. Brazing filler material is interposed between the metallized layer and the metal part.

JP 2008 311296 A discloses a ceramic substrate which is provided with rough-surface sections including the outer edge of the respective arrangement areas of the metal layer or a circuit layer along their outer edges. Smooth sections are surrounded by the rough-surface sections in the arrangement areas and are smoother than the rough-surface sections.

### SUMMARY

It is an object of the invention to provide an enhanced method for fixing heat resistant components, preferably in shape of plate-like ceramic tiles each limited by a peripheral boundary edge, on the surface of a heat exposed component using a molten solder, which enables that the heat resistant components are fastened on the surface in a solid and durable way and in particular free from thermal stresses.

The object is achieved by the sum total of the features in the independent claims 1, 2 and 5. The invention can be modified advantageously by the features disclosed in the sub claims as well in the following description especially referring to preferred embodiments.

Intensive investigations carried out by the inventors on joints between ceramic heat resistant components, in the following ceramic tiles, and a metallic surface of a heat exposed component, like turbine blades, showed that if edges of individual ceramic tiles are not bonded to the metal substrate, the ceramic tile will remain largely stress free under heat exposed conditions. In the opposite case, if the ceramic tiles are fully bonded up to their edges on the metallic surface large stresses can be develop causing a delamination of the individual tiles.

To avoid the before described delaminations of individual ceramic tiles from the metallic surface of the heat exposed component alternative methods are proposed inventively to avoid bonding the edges, preferably at least a part of the peripheral boundary edge of a ceramic tile on the surface of the heat exposed component. The technical problem behind the inventive methods was the quest for a robust method that would not impose any dimensional tolerances during production to ensure a defect free and proper joining between the ceramic tile and the heat exposed component.

According to a first alternative a method for fixing a heat resistant component, like a ceramic tile, on a surface of a heat exposed component by means of brazing of at least a part of a surface of the ceramic tile limited by a peripheral boundary edge on the surface of the heat exposed component using a molten solder it characterized inventively by metallizing the surface of the ceramic tile at least with the exception of an edge area comprising the peripheral boundary edge of the ceramic tile. After metallizing step the metallized surface of the ceramic tile is brazed to the surface of the heat exposed component in which the peripheral boundary edge of the ceramic tile remains excluded from the braze joint respectively solder joint.

To ensure that the molten solder during brazing does not cover and accordingly wet the ceramic surface area along the peripheral boundary edge of the ceramic tile both the ceramic material of the ceramic tile and the solder material are chosen in view of their physical-chemical properties in particular concerning wettability such that the molten solder doesn't have the affinity to wet the ceramic surface of the ceramic tile.

It is proposed to work with a braze metal alloy as solder material which does not wet the ceramic surface of the heat resistant component unless such surface has undergone metallization before. Thus the braze area respectively solder area, which corresponds to the joint area, can be defined in shape and size by the metallization process during which a metal layer is be coated onto a defined area of the surface of the ceramic tile as inventively required.

Alternatively to the before described method it is proposed inventively to coat at least an edge area comprising the peripheral boundary edge of the ceramic tile with a distance layer having a physical-chemical property concerning wettability such that the distance layer will not be wetted by the molten solder. In this case the ceramic material of the tile and the solder material are chosen such that the molten solder has a high affinity to wet the ceramic surface of the ceramic tile so that it is possible to create a direct solder joint between the ceramic tile and the metallic surface of the heat exposed component without the nee of a metallization step. It is important that the distance layer covers the edge area of the ceramic tile so that the distance layer prevents the molten solder to wet at least the edge area comprising the peripheral boundary edge of the ceramic tile.

The brazing step is carried out under a protective atmosphere at process temperatures up to 1200° C., i.e. without oxygen or at a reduced amount of oxygen, so that the distance layer will not suffer any damage. After brazing an additional burning step follows in which the distance layer covering at least the edge area comprising the peripheral boundary edge is burned out in way of oxidation under air atmosphere.

Preferably the distance layer is realized as a carbon or polymeric film layer which is applied on the edge area comprising at least a part, preferably the complete peripheral boundary edge of the heat resistant component which is preferably in shape of a plate-like component like a ceramic tile. The carbon or polymeric film can withstand the brazing process under a protective atmosphere so that it is ensured that the molten solder can not cover the edge area of the ceramic tile. After the brazing step the carbon or polymeric film can be burned out in air in way of oxidation ensuring a free standing edge which encloses a free gap together with the metal surface of the heat exposed component. The free gap has a gap measure in the dimension of the thickness of the burned out distance layer.

A third inventive alternative method for fixing a ceramic tile a surface of a heat exposed component proposes a structuring of the contact surface of the ceramic tile and/or the surface of the heat exposed component such that an edge area of the ceramic tile comprising the peripheral boundary edge does not have a contact to the surface of the heat exposed component after contacting both surfaces. In such case both surfaces have a physical-chemical property concerning wettability such that the surfaces are wettable by the molten solder.

Due to suitable structuring of at least one of the two surfaces to be joined by brazing the peripheral boundary edge of the ceramic tile encloses a free gap with the surface of the heat exposed component after brazing. One preferred embodiment for structuring will be illustrates in one of the following figures.

It is also possible to combine the third alternative method with the first and second alternative methods described before.

A preferred solder material respectively braze material is a braze metal alloy which has good wettability properties on metallic surfaces which are in case of the first inventive method described before the surface of the heat exposed component and the metallized surface of the ceramic tile.

The heat resistant component as mentioned before is in a preferred embodiment a ceramic tile which can be either a monolithic ceramic or ceramics with a multilayer structure or a ceramic matrix composite. The ceramic tile preferably has a plate thickness between 1 mm and 10 mm preferably 6 mm and a plate surface size between 0,5 cm² and 10 cm². The expression “heat resistant component” is not limited to a ceramic tile, rather all ceramic bodies which are suitable for applying onto the surface of a heat exposed component in particular metal components of a combustor or turbine of a gas turbine or steam turbine arrangement are conceivable.

### BRIEF DESCRIPTION OF THE DRAWINGS

The invention shall subsequently be explained in more detail based on exemplary embodiments in conjunction with the drawing. In the drawing

FIG. 1 cross section view through a joint between a ceramic tile and a metallic substrate using metallization,

FIG. 2 cross section view through a joint between a ceramic tile and a metallic substrate using a distance layer, and

FIG. 3a,b cross section views of a joint between a structured ceramic tile and a metallic substrate.

### DETAILED DESCRIPTION

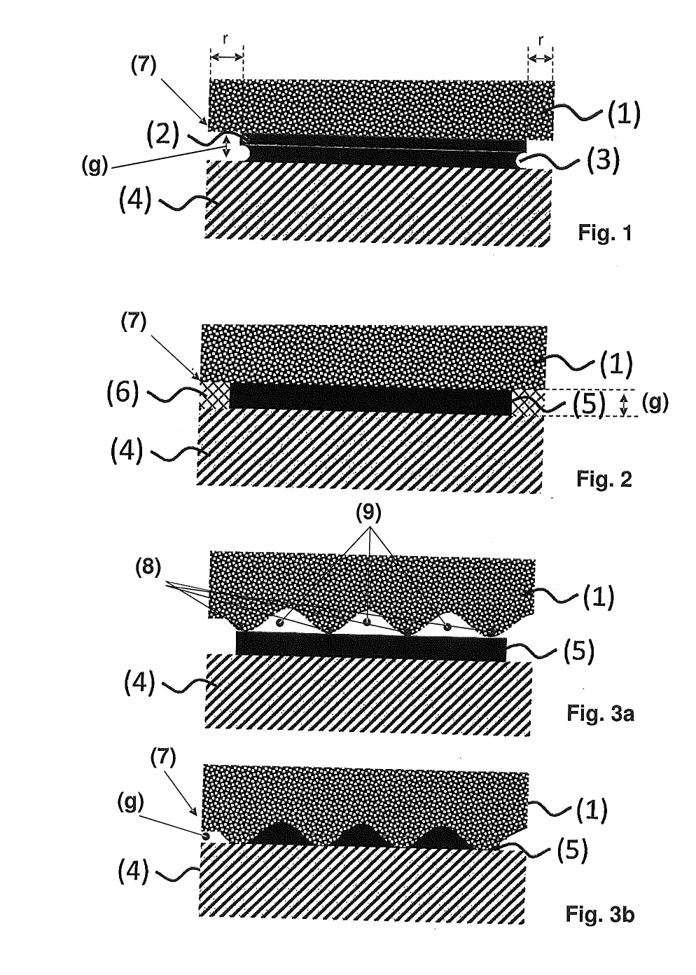

FIG. 1 shows a cross section view of a joint between a heat resistant component 1 made of ceramic material which is in shape of a tile, and a heat exposed component 4 providing a metallic surface. The heat exposed component 4 preferably is a metallic component of a gas or steam turbine arrangement, for example a combustion liner of a combustor, a blade, vane or heat shield element of a turbine.

To enhance the heat resistant of the heat exposed component 4 the ceramic tile 1 is bonded onto the metallic surface of the heat exposed component 4. To avoid significant thermal stresses in ceramic tile 1 the edges 7 of the ceramic tile 1 are free and excluded from the bond joint between both components 1 and 4. To realize the gap g between the peripheral boundary edge 7 and the metallic surface of the heat exposed component 4 the ceramic tile 1 is metallized in a first step before joining at the surface facing the heat exposed component 4. Metallization is performed such that the edge area comprising the peripheral boundary edge 7 is excluded from metallization so that a rim area r along the peripheral boundary edge 7 will remain as ceramic surface. After metallization a metallic layer 2 covers a part of the surface of the ceramic tile 1 facing the metallic surface of the heat exposed component 4.

In a following step the metallic surface of the heat exposed component 4 is brazed onto the metallized surface 2 using a molten solder 3 which wets the surface of the metallized surface 2 only but which is not able to wet the free ceramic surface at the rim area r of the ceramic tile 1 in the edge area comprising the peripheral boundary edge 7.

After brazing a gap g near the peripheral boundary edge 7 will remain between the ceramic tile 1 and the heat exposed component 4.

FIG. 2 shows an alternative embodiment for creating a gap g between the edge area comprising the peripheral bound edge 7 of the ceramic tile 1 and the heat exposed component 4.

In case of FIG. 2 the edge area comprising the peripheral boundary edge 7 is coated first with a distance layer 6 which acts as a physical barrier preventing the molten solder from spreading over the whole ceramic surface of the ceramic tile 1. The distance layer 6, preferably is of carbon or polymeric material, ensures that molten solder cannot wet the edge area comprising the peripheral boundary edge 7. The wettability of the ceramic surface of the ceramic tile 1 and the molten solder material are chosen such that the molten solder is able to wet the ceramic surface of the ceramic tile 1 as well the metallic surface of the heat exposed component 4. The brazing process will be carried out under protective atmosphere conditions so that the distance layer 6 can get through the brazing step without damage. FIG. 2 shows the result after the brazing step. To remove the distance layer 6 a further burning process under air conditions is necessary to burn out the distance layer 6 by oxidation processes to create the free gap between the edge area and the metallic surface of the heat exposed component 4.

FIG. 3a and b show a further alternative method for fixing a heat resistant component in shape of a ceramic tile 1 on a metallic surface of a heat exposed component 4 by brazing. In difference to the embodiments described in connection with FIGS. 1 and 2 in which the surfaces to be brazed together are of plane shape, the surface of the ceramic tile 1 is structured wave-like so that the peripheral boundary edge 7 is disposed recessed relative to wave-crest points 8 of the structured surface of the ceramic tile 1.

Further the braze respectively solder material 5 is chosen such that the molten solder 5 wets the ceramic structured surface of the ceramic tile 1 as well the metallic surface of the heat exposed component 4. The layer thickness and the surface dimension of the solder material 5 correspond with the recess volume of the structured ceramic surface of the tile 1 so that the molten solder material 5 fills out the space 9 which is enclosed by both surfaces of the ceramic tile and heat exposed components 1, 4 being in contact with each other.

FIG. 3b shows the joint after brazing in which the space 9 is filled completely with solder material 5. Further no solder material 5 is in the gap g between the edge area comprising the peripheral boundary edge 7 and the metal surface of the heat exposed component 4.

It is also possible to structure the metallic surface of the heat exposed component 4 alternatively or in combination with structuring the surface of the ceramic tile 1 shown in FIGS. 3a and b. Further is conceivable to apply structuring of the surfaces like in case of FIG. 3a, b also in the embodiments shown in FIGS. 1 and 2.

1. A method for fixing a heat resistant component on a surface of a heat exposed component, by brazing of at least a part of a surface of the heat resistant component limited by a peripheral boundary edge on the surface of the heat exposed component using a molten solder, comprising:
metallizing the surface of the heat resistant component at least with the exception of an edge area comprising the peripheral boundary edge and
brazing said metallized surface to the surface of the heat exposed component, wherein:
at least the surface of the heat resistant component consists of a ceramic material which has a physico-chemical property concerning wettability such that the ceramic material is not wettable by the molten solder, and/or
a metal or a metal alloy is used for metallizing which has a physico-chemical property concerning wettability such that the metallizing is wettable by the molten solder.

2. A method for fixing heat resistant component on a surface of a heat exposed component; the method comprising brazing of at least a part of a surface of the heat resistant component limited by a peripheral boundary edge on the surface of the heat exposed component using a molten solder,
coating at least an edge area comprising the peripheral boundary edge of the heat resistant component with a distance layer having a physico-chemical property concerning wettability such that the distance layer is not wettable by the molten solder and
brazing the surface of the heat resistant component, having a physico-chemical property concerning wettability such that the surface is wettable by the molten solder, to the surface of the heat exposed component.

3. The method according to claim 2, wherein the brazing is carried out under a protective atmosphere, i.e. without oxygen or a reduced amount of oxygen, and that after brazing a burning step follows in which the distance layer covering at least the edge area comprising the peripheral boundary edge is burned out under air atmosphere.

4. The method according to claim 2, wherein at least the surface of the heat resistant component consists is of a ceramic material, the distance layer consists of carbon or a polymeric material and the solder consists of a metal or metal alloy.

5. A method for fixing a heat resistant component on a surface of a heat exposed component, by brazing a contact surface of the heat resistant component limited by a peripheral boundary edge on the surface of the heat exposed component using a molten solder or according to claim 4, the method comprising:
structuring the contact surface of the heat resistant component and/or the surface of the heat exposed component such that an edge area of the heat resistant component comprising the peripheral boundary edge does not have a contact to the surface of the heat exposed component after contacting both surfaces and
brazing said surfaces, each having a physico-chemical property concerning wettability such that the surfaces are wettable by the molten solder.

6. The method according to claim 5, wherein the structuring is performed such that after brazing the peripheral boundary edge of the heat resistant component enclosing a free gap with the surface of the heat exposed component.

7. The method according to claim 1, wherein the solder is a braze metal alloy.

8. The method according to claim 1, wherein the surface of the heat exposed component is of metallic material which has a physico-chemical property concerning wettability such that the metal is wettable by the molten solder.

9. The method according to claim 1, wherein the heat resistant component is a plate-like component of ceramic material having a plate thickness between 1 mm and 10 mm, preferably 6 mm and a plate surface size between 0,5 cm² and 10 cm².
